(19) United States
(12) Patent Application Publication
(10) Pub. No.: US 2023/0022329 A1
(43) Pub. Date: Jan. 26, 2023

(54) ELECTRODES AND ELECTROCHEMICAL CELLS WITH POSITIVE TEMPERATURE COEFFICIENT MATERIALS AND METHODS OF PRODUCING THE SAME

(71) Applicant: 24M Technologies, Inc., Cambridge, MA (US)

(72) Inventors: Junzheng CHEN, Concord, MA (US); Naoki OTA, Lexington, MA (US); Matthew R. TYLER, Boston, MA (US); Landon OAKES, Cambridge, MA (US)

(21) Appl. No.: 17/869,310

(22) Filed: Jul. 20, 2022

Related U.S. Application Data
(60) Provisional application No. 63/275,655, filed on Nov. 4, 2021.
(60) Provisional application No. 63/242,605, filed on Sep. 10, 2021.
(60) Provisional application No. 63/224,232, filed on Jul. 21, 2021.

(51) Int. Cl. H01M 50/581; H01M 4/62

(52) U.S. Cl. CPC H01M 50/581; H01M 4/62; H01M 2200/106

(57) ABSTRACT

Embodiments described herein relate to electrodes and electrochemical cells with positive temperature coefficient coatings and methods of producing the same. In some embodiments, an electrode can include a layer of a film material, a positive temperature coefficient (PTC) coating disposed in the layer of film material. The PTC material resists a flow of current through at least a portion of the PTC material when a temperature of the at least a portion of the PTC material exceeds a threshold value. The electrode further includes an electrode material disposed on the PTC material. In some embodiments, the electrode can further include an electrode tab coupled to the PTC material and the electrode film. In some embodiments, the PTC material can include a conductive polymer. In some embodiments, the electrode material can include a semi-solid and/or a binderless electrode material.

### CROSS-REFERENCE TO RELATED APPLICATIONS

This application claims priority to U.S. Provisional Patent Application No. 63/224,232, titled “Electrodes and Electrochemical Cells with Positive Temperature Coefficient Materials and Methods of Producing the Same,” filed on Jul. 21, 2021, U.S. Provisional Patent Application No. 63/242,605, titled “Electrodes and Electrochemical Cells with Positive Temperature Coefficient Materials and Methods of Producing the Same,” filed on Sep. 10, 2021, U.S. Provisional Patent Application No. 63/275,655, titled “Electrodes and Electrochemical Cells with Positive Temperature Coefficient Materials and Methods of Producing the Same,” filed on Nov. 4, 2021, the disclosures of which are incorporated by reference herein in their entireties.

### TECHNICAL FIELD

Embodiments described herein relate to electrodes and electrochemical cells with positive temperature coefficient (PTC) coatings and methods of producing the same.

### BACKGROUND

Lithium-ion batteries deliver renewable energy and have high energy density, compared to other cell chemistry. However, thermal runaway is a significant safety issue in such cells. Heat generated during charge and discharge can facilitate chemical reactions. The chemical reactions can produce even more heat, and this cycle can continue. Such occurrences can damage cell materials and potentially cause injuries. Incorporation of materials into electrochemical cells that can limit thermal runaway can prevent such occurrences.

### SUMMARY

Embodiments described herein relate to electrodes and electrochemical cells with positive temperature coefficient coatings and methods of producing the same. In some embodiments, an electrode can include a layer of a film material, a positive temperature coefficient (PTC) coating disposed in the layer of film material. The PTC material resists a flow of current through at least a portion of the PTC material when a temperature of the at least a portion of the PTC material exceeds a threshold value. The electrode further includes an electrode material disposed on the PTC material. In some embodiments, the electrode can further include an electrode tab coupled to the PTC material and the electrode film. In some embodiments, the PTC material can include a conductive polymer. In some embodiments, the electrode material can include a semi-solid and/or a binderless electrode material.

### BRIEF DESCRIPTION OF THE DRAWINGS

FIG. 1 shows a schematic illustration of an electrode with a PTC material, according to an embodiment.

FIG. 2 shows a schematic illustration of an electrochemical cell with a PTC material, according to an embodiment.

FIGS. 3A-3B illustrate an electrochemical cell with a PTC material, according to an embodiment.

FIG. 4 illustrates an electrochemical cell with a PTC material, according to an embodiment.

FIGS. 5A-5B illustrate an electrochemical cell with a PTC material, according to an embodiment.

FIGS. 6A-6B illustrate an electrode with a PTC material, according to an embodiment.

FIGS. 7A-7B illustrate an electrode with a PTC material, according to an embodiment.

FIG. 8 shows cycling data of an electrochemical cell with an anode weld tab coupled directly to an anode.

### DETAILED DESCRIPTION

Embodiments described herein relate to electrochemical cells with PTC materials and/or PTC coatings incorporated into one or more of the electrodes. PTC materials can have temperature-dependent electrical resistance. Upon an increase in temperature, the PTC material experiences an increase in electrical resistance. This can slowly reduce the amount of current that passes through the electrode, easing temperature increase. Eventually, if the temperature increase is sufficient to completely stop the flow of current through the electrode, the cell becomes inactive or dormant. In some embodiments, the increased resistance can be reversible, such that the cell can continue to function once again upon cooling. As an example scenario, an external stimulus such as a nail may drive through the electrochemical cell and cause a short circuit event in the electrochemical cell. The PTC material can prevent or substantially prevent flow of electrons therethrough after a minimal temperature increase in the electrochemical cell. This can prevent thermal runaway and improve the safety of the electrochemical cell.

In some embodiments, the electrochemical cells described herein can include a semi-solid cathode and/or a semi-solid anode. In some embodiments, the semi-solid electrodes described herein can be binderless and/or can use less binder than is typically used in conventional battery manufacturing. The semi-solid electrodes described herein can be formulated as a slurry such that the electrolyte is included in the slurry formulation. This is in contrast to conventional electrodes, for example calendered electrodes, where the electrolyte is generally added to the electrochemical cell once the electrochemical cell has been disposed in a container, for example, a pouch or a can.

In some embodiments, the electrode materials described herein can be a flowable semi-solid or condensed liquid composition. In some embodiments, a flowable semi-solid electrode can include a suspension of an electrochemically active material (anodic or cathodic particles or particulates), and optionally an electronically conductive material (e.g., carbon) in a non-aqueous liquid electrolyte. In some embodiments, the active electrode particles and conductive particles can be co-suspended in an electrolyte to produce a semi-solid electrode. In some embodiments, electrode materials described herein can include conventional electrode materials (e.g., including lithium metal).

Examples of electrodes, electrolyte solutions, and methods that can be used for preparing the same are described in U.S. Pat. No. 9,437,864 (hereafter “the '864 Patent”) filed Mar. 10, 2014, entitled “Asymmetric Battery Having a Semi-Solid Cathode and High Energy Density Anode,” the entire disclosure of which is incorporated herein by reference in its entirety. Additional examples of electrodes, electrolyte solutions, and methods that can be used for preparing the same are described in U.S. Pat. No. 9,484,569 (hereafter “the '569 Patent”), filed Mar. 15, 2013, entitled “Electrochemical Slurry Compositions and Methods for Preparing the Same,” U.S. Pat. No. 10,637,038 (hereafter “the '038 Patent”), filed Nov. 4, 2015, entitled “Electrochemical Cells Having Semi-Solid Electrodes and Methods of Manufacturing the Same,” and U.S. Pat. No. 8,993,159 (hereafter “the '159 Patent”), filed Apr. 29, 2013, entitled “Semi-Solid Electrodes Having High Rate Capability,” the entire disclosures of which are hereby incorporated by reference herein. Examples of electrochemical cells with minimal or reduced current collectors are described in U.S. Patent publication No. 2021/0265631 (hereafter “the '631 publication”), filed Feb. 22, 2021, the entire disclosure of which is hereby incorporated by reference herein.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, a “direct coupling” refers to two pieces of material physically touching each other.

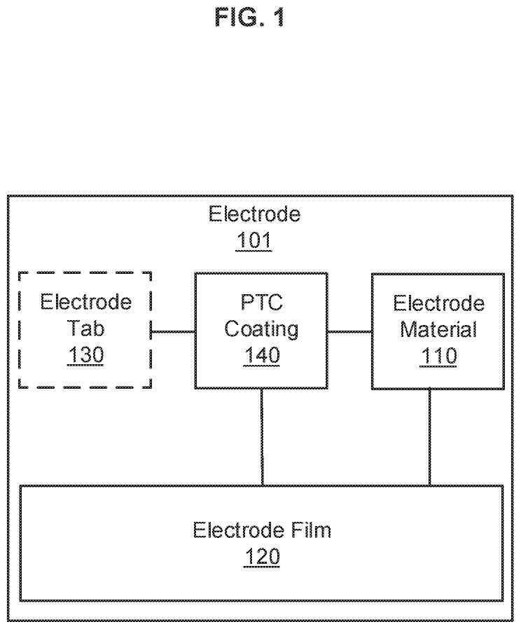

FIG. 1 is a schematic drawing of an electrode 101, with a PTC material, according to an embodiment. As shown, the electrode 101 includes an electrode material 110 and an electrode film 120. The electrode 101 optionally includes an electrode tab 130. The electrode 101 includes a PTC material 140. In some embodiments, the PTC material 140 can include a PTC coating. In some embodiments, the PTC material 140 can be coated onto the electrode film 120. In some embodiments, the PTC material 140 can be coated onto the electrode material 110. In some embodiments, the PTC material 140 can be coated onto a separator (not shown). In some embodiments, the electrode material 140 can include a semi-solid and/or binderless electrode material.

Incorporation of the PTC material 140 into the electrode 101 can help prevent thermal runaway in an electrochemical cell. The PTC material 140 increases in electrical resistance when its temperature increases. In some embodiments, the current through the PTC material 140 can gradually decrease with increasing temperature. In some embodiments, current through the PTC material can be stopped or substantially stopped when the PTC material 140 reaches a threshold temperature.

In some embodiments, the PTC material 140 can deform when it reaches the threshold temperature, such that electrical contact between the electrode material 110 and the electrode tab 130 is interrupted. In some embodiments, the deformation of the PTC material 140 can cause a terminal end of the PTC material 140 to move such that it no longer contacts the electrode material 110. In some embodiments, the deformation of the PTC material 140 can cause a terminal end of the PTC material 140 to move such that it no longer contacts the electrode tab 130.

As shown, the PTC material 140 is coupled to the electrode material 110 and the electrode film 120, and optionally to the electrode tab 130. In some embodiments, the PTC material 140 can be applied to the electrode material 110 during production of the electrode 101. In some embodiments, the PTC material 140 can be applied to the electrode film 120 during production of the electrode 101. In some embodiments, the PTC material 140 can be applied to both the electrode material 110 and the electrode film 120 during production of the electrode 101. In some embodiments, the PTC coating 140 can extend along a full length of the electrode material 110. In some embodiments, the PTC coating 140 can cover a full surface lengthwise of the electrode material 110. In some embodiments, the PTC coating 140 can extend along a portion of the full length of the electrode material 110. In some embodiments, the PTC coating 140 can cover a portion of a full surface lengthwise of the electrode material 110.

In some embodiments, the electrode 101 can be without a current collector. In the absence of a current collector, the flow of electrons through the electrode 101 can be stopped when the temperature of the PTC material 140 reaches a threshold value. Upon reaching the threshold temperature, the PTC material 140 has effectively become an insulator, and prevents an electric coupling between the voltage source and the electrode material 110. The electrode tab 130 can be coupled to the PTC material 140 without directly touching the electrode material 110, such that the PTC material 140 prevents movement of electrodes between the electrode material 110 and the electrode tab 130 when the temperature in the PTC material 140 reaches the threshold value. In some embodiments, the PTC material 140 can be directly coupled to the electrode material 110. In some embodiments, the PTC material 140 can be directly coupled to the electrode film 120. In some embodiments, the PTC material 140 can be directly coupled to the electrode tab 130.

In some embodiments, the PTC material 140 can be composed of poly-crystalline materials, conductive polymers, barium carbonate, titanium oxide, tantalum, silica, manganese, activated carbon, hard carbon, graphite, carbon grains, or any combination thereof. In some embodiments, the PTC material 140 can be a composite material. In some embodiments, the PTC material 140 can include a polymer with carbon grains embedded therein. In such a case, the carbon grains are in close contact with one another when the PTC material 140 is at a low temperature and the carbon grains expand and spread out from one another when the PTC material 140 is at a high temperature. In some embodiments, the PTC material 140 can include doped silicon. In some embodiments, the PTC material 140 can include a BaTiO₃ ceramic oxidative layer or grain boundary layer (GBL) capacitor. In some embodiments, the PTC material 140 can include a barium host structure. In some embodiments, the PTC material 140 can include a titanium host structure.

In some embodiments, the PTC material 140 can include a polymer with a filler. In some embodiments, the polymer can be crosslinked. In some embodiments, the polymer can be free or substantially free of crosslinking. In some embodiments, the PTC material 140 can include multiple polymers. In some embodiments, the PTC material 140 can have a crystallinity of at least about 5%, at least about 10%, at least about 15%, at least about 20%, at least about 25%, or at least about 30%, inclusive of all values and ranges therebetween. In some embodiments, the PTC material 140 can include one or more thermoplastics. In some embodiments, the PTC material 140 can include one or more crosslinked thermoplastics. In some embodiments, the PTC material 140 can include one or more elastomers, thermoplastic elastomers, thermosetting resins, or combinations thereof. In some embodiments, the PTC material 140 can include polyolefins (e.g., polyethylene) copolymers comprising units derived from one or more olefins (e.g., ethylene and propylene) and one or more olefinically unsaturated monomers containing polar groups (e.g., vinyl esters and acids and esters of a-unsaturated organic acids. In some embodiments, the PTC material 140 can include halogenated vinyl, vinylidene polymers (e.g., polyvinyl chloride, polyvinylidene chloride, polyvinyl fluoride, polyvinylidene fluoride), polyamides, polystyrene, polyacrylonitrile, thermoplastic silicone resins, thermoplastic polyethers, thermoplastic modified celluloses, and/or polysulfones.

In some embodiments, the PTC material 140 can include a filler. In some embodiments, the filler can include particles that include carbon black or a non-conductive material, and/or particles that include a metal. In some embodiments, the metal can include nickel, tungsten, and/or molybdenum. In some embodiments, the metal can include silver, gold, platinum, iron, aluminum, copper, tantalum, zinc, cobalt, chromium, lead, titanium, tin and/or an alloy (e.g., Nichrome or brass). In some embodiments, the metal can have a Brinell hardness of at least about 80, at least about 90, or at least about 100, inclusive of all values and ranges therebetween. In some embodiments, the filler can include graphite.

In some embodiments, the PTC material 140 can have a thickness of at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, or at least about 450 μm. In some embodiments, the PTC material 140 can have a thickness of no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, or no more than about 30 μm. Combinations of the above-referenced thicknesses of the PTC material 140 are also possible (e.g., at least about 20 μm and no more than about 500 μm or at least about 100 μm and no more than about 200 μm), inclusive of all values and ranges therebetween. In some embodiments, the PTC material 140 can have a thickness of about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, or about 500 μm.

In some embodiments, the PTC material 140 can prevent passage of electrons therethrough upon reaching a threshold temperature. In some embodiments, the threshold temperature can be at least about 30° C., at least about 40° C., at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., or at least about 290° C. In some embodiments, the threshold temperature can be no more than about 300° C., no more than about 290° C., no more than about 280° C., no more than about 270° C., no more than about 260° C., no more than about 250° C., no more than about 240° C., no more than about 230° C., no more than about 220° C., no more than about 210° C., no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., no more than about 90° C., no more than about 80° C., no more than about 70° C., no more than about 60° C., no more than about 50° C., or no more than about 40° C.

Combinations of the above-referenced threshold temperatures are also possible (e.g., at least about 30° C. and no more than about 300° C. or at least about 80° C. and no more than about 200° C.), inclusive of all values and ranges therebetween. In some embodiments, the threshold temperature can be about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., or about 300° C.

In some embodiments, the PTC material 140 can include coated microcapsules. The coated microcapsules can include a non-conductive material coated with a conductive material. Upon reaching the threshold temperature, the microcapsules can burst or melt and prevent further conductivity through the PTC material 140.

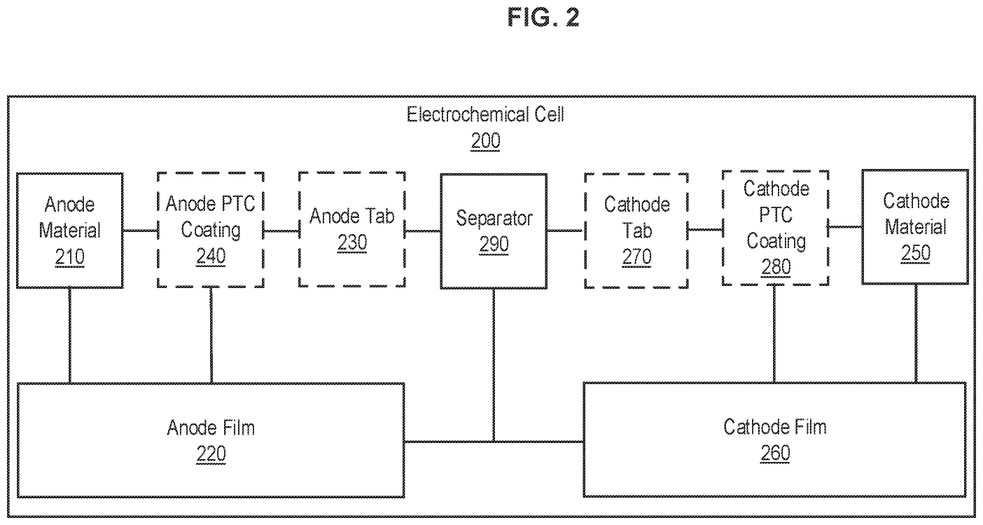

FIG. 2 is a schematic drawing of an electrochemical cell 200, according to an embodiment. As shown, the electrochemical cell 200 includes an anode material 210, an anode film 220, optionally an anode tab 230, optionally an anode PTC material 240, a cathode material 250, a cathode film 260, optionally a cathode tab 220, optionally a cathode PTC material 280, and a separator 290. In some embodiments, the anode PTC material 240 can be the same or substantially similar to the PTC material 140, as described above with reference to FIG. 1. In some embodiments, the cathode PTC material 280 can be the same or substantially similar to the PTC material 140, as described above with reference to FIG. 1. In some embodiments, the anode material 210 and/or the cathode material 250 can be the same or substantially similar to the electrode material 110, as described above with reference to FIG. 1. In some embodiments, the anode tab 230 and/or the cathode tab 270 can be the same or substantially similar to the electrode tab 130, as described above with reference to FIG. 1. In some embodiments, the anode film 220 and/or the cathode film 260 can be the same or substantially similar to the electrode film 120, as described above with reference to FIG. 1. Thus, certain aspects of the anode material 210, the anode film 220, the anode tab 230, the anode PTC material 240, the cathode material 250, the cathode film 260, the cathode tab 270, and the cathode PTC material 280 are not described in greater detail herein.

In some embodiments, the anode material 210 can be coupled to the anode PTC material 240 while the cathode material 250 is coupled to a conventional current collector (not shown), and the cathode PTC material 280 is not included in the electrochemical cell 200. In some embodiments, the cathode material 250 can be coupled to the cathode PTC material 280 while the anode material 210 is coupled to a conventional current collector (not shown), and the anode PTC material 240 is not included in the electrochemical cell 200.

The anode film 220 and the cathode film 260 can form a pouch. In some embodiments, a single electrochemical cell can be disposed in a pouch. In some embodiments, the anode film 220 and the cathode film 260 can be cut via a punching process to form the electrochemical cell 200. In some embodiments, the anode film 220 and the cathode film 260 can be cut via a laser, (e.g., a CO₂-gas laser, a high-powered diode laser, fiber optic laser, etc.), a punch, a press, pneumatic cutting, drilling, plasma cutting, a reciprocating blade, hydraulic cutting, or any other suitable process or combinations thereof. to form the electrochemical cell 200. The separator 290 maintains physical separation between the anode material 210 and the cathode material 250 while allowing passage of electroactive material therethrough.

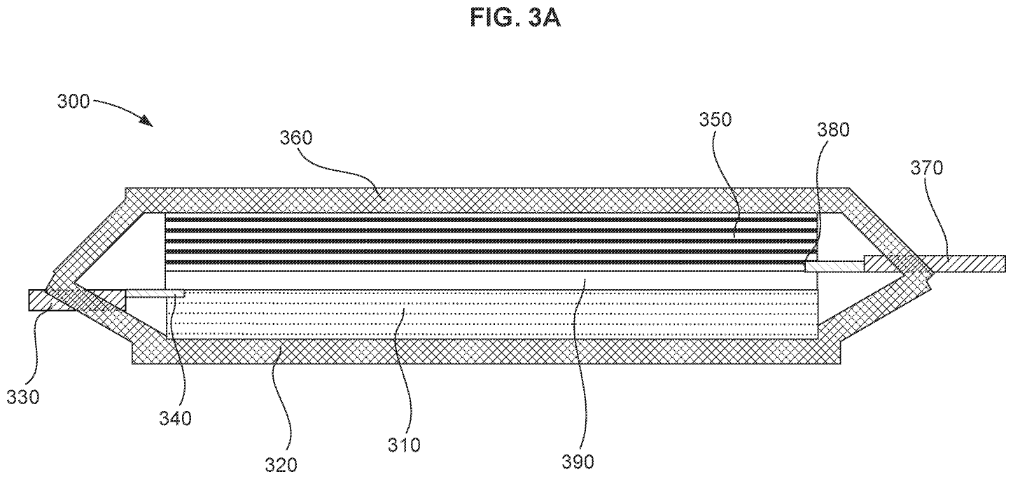

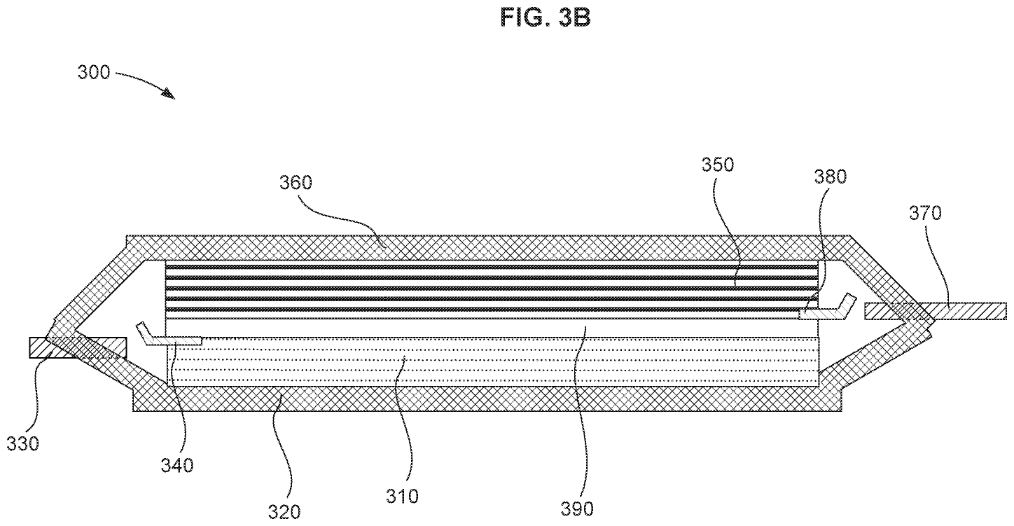

FIGS. 3A and 3B are illustrations of an electrochemical cell 300, according to an embodiment. As shown, the electrochemical cell 300 includes an anode material 310, an anode film 320, an anode tab 330, an anode PTC material 340, a cathode material 350, a cathode film 360, a cathode tab 370, a cathode PTC material 380, and a separator 390. In some embodiments, the anode material 310, the anode film 320, the anode tab 330, the anode PTC material 340, the cathode material 350, the cathode film 360, and the cathode tab 370, the cathode PTC material 380, and the separator 390 can be the same or substantially similar to the anode material 210, the anode film 220, the anode tab 230, the anode PTC material 240, the cathode material 250, the cathode film 260, the cathode tab 270, the cathode PTC material 280, and the separator 290, as described above with reference to FIG. 2. Thus, certain aspects of the anode material 310, the anode film 320, the anode tab 330, the anode PTC material 340, the cathode material 350, the cathode film 360, the cathode tab 370, the cathode PTC material 380, and the separator 390 are not described in greater detail herein.

As shown in FIG. 3A, the anode tab 330 is coupled to the anode PTC material 340. In some embodiments, a section of the anode PTC material 340 can be removed or machined away to allow space for the anode tab 330. In some embodiments, the anode tab 330 can be welded to the anode PTC material 340. As shown, the cathode tab 370 is coupled to the cathode PTC material 340. In some embodiments, a section of the cathode PTC material 380 can be removed or machined away to allow space for the cathode tab 370. In some embodiments, the cathode tab 370 can be welded to the cathode PTC material 380.

As shown, the anode PTC material 340 extends along a portion of the anode material 310. In some embodiments, the anode PTC material 340 can extend along about 5%, about 10%, about 20%, about 30%, about 40%, or about 50% of the anode material 310, inclusive of all values and ranges therebetween. As shown, the cathode PTC material 380 extends along a portion of the cathode material 350. In some embodiments, the cathode PTC material can extend along about 5%, about 10%, about 20%, about 30%, about 40%, or about 50% of the cathode material 350, inclusive of all values and ranges therebetween.

As shown in FIG. 3B, the anode PTC material 340 has deformed due to an increase in temperature, and the anode material 310 is no longer electrically coupled to the anode tab 330. Also in FIG. 3B, the cathode PTC coating 380 has deformed due to an increase in temperature, and the cathode material 350 is no longer electrically coupled to the cathode tab 370. In some embodiments, the anode PTC material 340 can deform at a lower temperature than the cathode PTC material 380, such that the anode PTC material 340 deforms while the cathode PTC material 380 remains in its original form or substantially similar to its original form. In some embodiments, the cathode PTC material 380 can deform at a lower temperature than the anode PTC material 340, such that the cathode PTC material 380 deforms while the anode PTC material 340 remains in its original form or substantially similar to its original form.

In some embodiments, a hole or slot can be cut into the anode film 320 such that the anode tab 330 can be inserted into the anode film 320 and coupled to the anode PTC material 340. In some embodiments, the anode film 320 can be laminated to the anode tab 330 to create a seal around the anode tab 330. In some embodiments, a hole or slot can be cut into the cathode film 380 such that the cathode tab 370 can be inserted into the cathode film 360 and coupled to the cathode PTC material 380. In some embodiments, the cathode film 360 can be laminated to the cathode tab 370 to create a seal around the cathode tab 370. In some embodiments, the hole or slot cut into the anode film 320 and/or the cathode film 360 can be cut via a CO₂ laser, a rotary die, a blade, or any combination thereof. In some embodiments, the hole or slot can be punched into the anode film 320 and/or the cathode film 360.

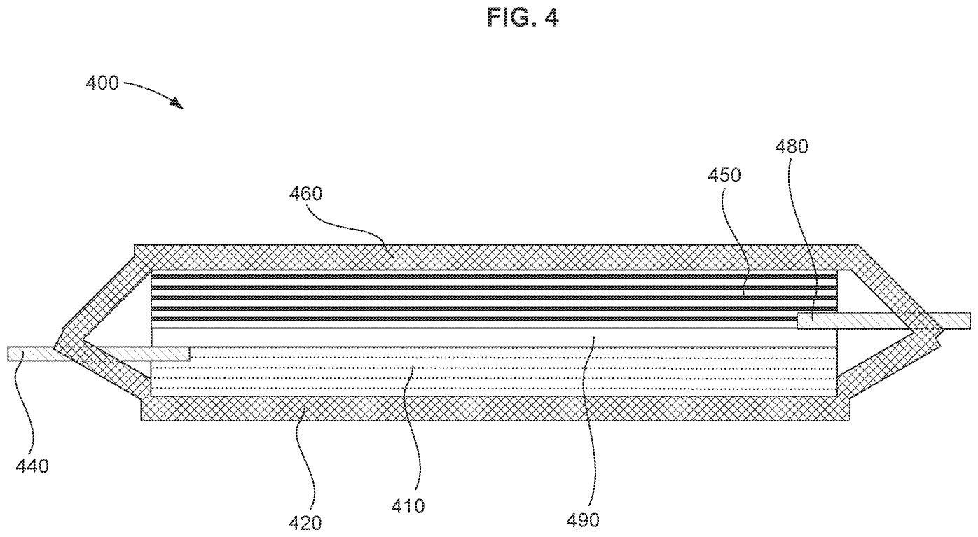

FIG. 4 is an illustration of an electrochemical cell 400, according to an embodiment. As shown, the electrochemical cell 400 includes an anode material 410, an anode film 420, an anode PTC material 440, a cathode material 450, a cathode film 460, a cathode PTC material 480, and a separator 490. In some embodiments, the anode material 410, the anode film 420, the anode PTC material 440, the cathode material 450, the cathode film 460, the cathode PTC material 480, and the separator 490 can be the same or substantially similar to the anode material 210, the anode film 220, the anode PTC material 240, the cathode material 250, the cathode film 260, the cathode PTC material 280, and the separator 290, as described above with reference to FIG. 2. Thus, certain aspects of the anode material 410, the anode film 420, the anode PTC material 440, the cathode material 450, the cathode film 460, the cathode PTC material 480, and the separator 490 are not described in greater detail herein.

As shown, the anode film 420 and the cathode film 460 form a pouch. The anode PTC material 440 extends to the outside of the pouch to expose a portion of the anode PTC material 440 for connecting to a voltage source. In other words, the anode PTC material 440 extends to the outside of the pouch such that a portion of the anode PTC material 440 acts as an anode tab without an additional piece of tab material coupled to the anode PTC material 440. As shown, the cathode PTC material 480 extends to the outside of the pouch to expose a portion of the cathode PTC material 480 for connecting to a voltage source. In other words, the cathode PTC material 480 extends to the outside of the pouch such that a portion of the cathode PTC material 480 acts as a cathode tab without an additional piece of tab material coupled to the cathode PTC material 480. In some embodiments, the anode PTC material 440 can include an anode tab (e.g., the anode tab 330, as described above with reference to FIG. 3A-3B) coupled thereto while the cathode PTC material 480 does not include a cathode tab coupled thereto. In some embodiments, the cathode PTC material 480 can include a cathode tab (e.g., the cathode tab 370, as described above with reference to FIGS. 3A-3B) coupled thereto while the anode PTC material 440 does not include an anode tab coupled thereto.

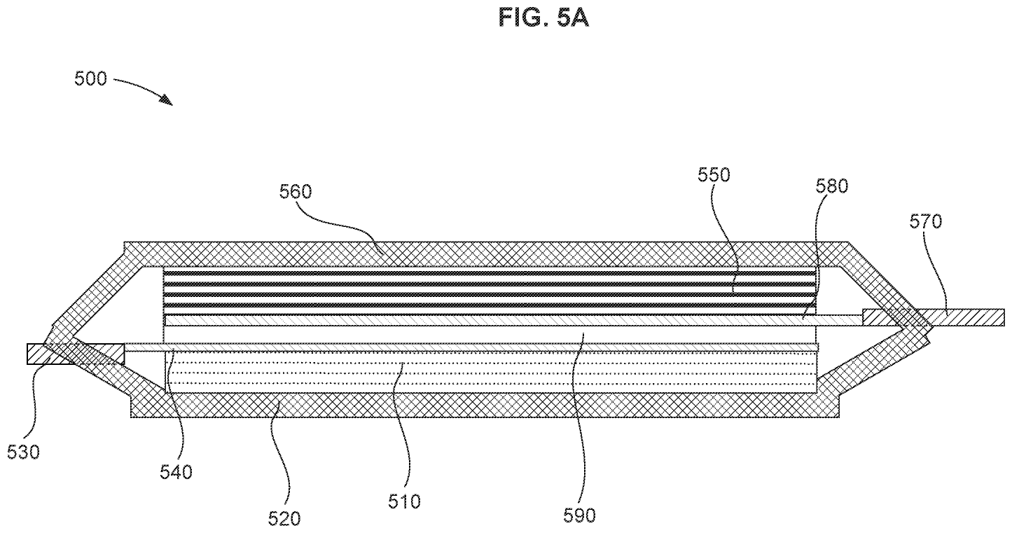

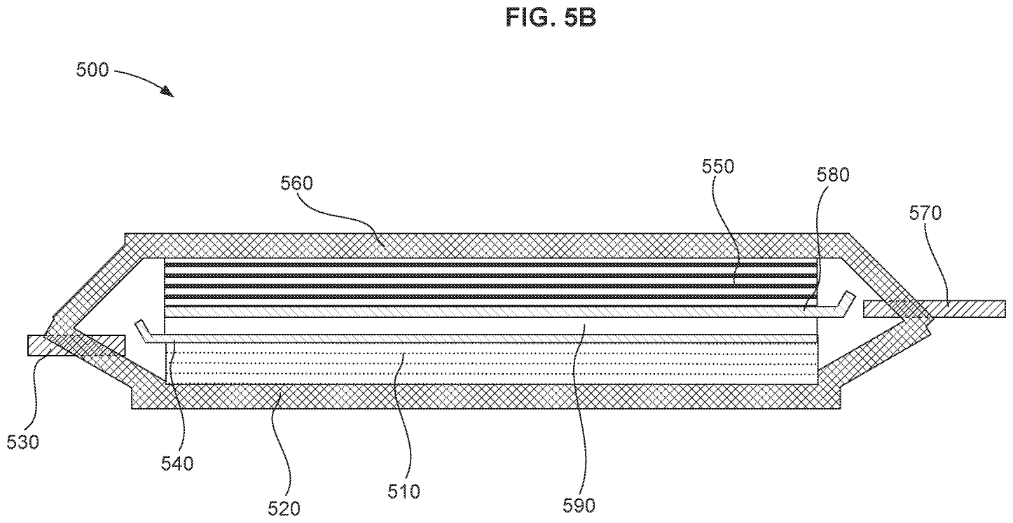

FIGS. 5A and 5B are illustrations of an electrochemical cell 500, according to an embodiment. As shown, the electrochemical cell 500 includes an anode material 510, an anode film 520, an anode tab 530, an anode PTC material 540, a cathode material 550, a cathode film 560, a cathode tab 570, a cathode PTC material 580, and a separator 590. In some embodiments, the anode material 510, the anode film 520, the anode tab 530, the anode PTC material 540, the cathode material 550, the cathode film 560, the cathode tab 570, the cathode PTC material 580, and the separator 590 can be the same or substantially similar to the anode material 310, the anode film 320, the anode tab 330, the anode PTC material 340, the cathode material 350, the cathode film 360, the cathode tab 370, the cathode PTC material 380, and the separator 390, as described above with reference to FIGS. 3A and 3B. Thus, certain aspects of the anode material 510, the anode film 520, the anode tab 530, the anode PTC material 540, the cathode material 550, the cathode film 560, the cathode tab 570, the cathode PTC material 580, and the separator 590 are not described in greater detail herein.

As shown, the anode PTC material 540 is disposed between the anode material 510 and the separator 590. In some embodiments, the anode PTC material 540 can be disposed between the anode material 510 and the anode film 520. As shown, the cathode PTC material 580 is disposed between the cathode material 550 and the separator 590. In some embodiments, the cathode PTC material 580 can be disposed between the cathode material 550 and the cathode film 560.

In FIG. 5A, the anode PTC material 540 is shown having a temperature below the threshold temperature of the anode PTC material 540 and has not deformed to interrupt the electrical connection between the anode material 510 and the anode tab 530. In FIG. 5B, the anode PTC material 540 has deformed to interrupt the electrical connection between the anode material 510 and the anode tab 530. In FIG. 5A, the cathode PTC material 580 is shown having a temperature below the threshold temperature of the cathode PTC material 580 and has not deformed to interrupt the electrical connection between the cathode material 550 and the cathode tab 570. In FIG. 5B, the cathode PTC material 580 has deformed to interrupt the electrical connection between the cathode material 550 and the cathode tab 570.

As shown, the anode PTC material 540 extends along the full length of the anode material 510. As shown, the cathode PTC material 580 extends along the full length of the cathode material 550. In some embodiments, the anode PTC material 540 can extend along the full length of the anode material 510 while the cathode PTC material 580 extends along a portion of the full length of the cathode material 550. In some embodiments, the cathode PTC material 580 can extend along the full length of the cathode material 550 while the anode PTC material 540 extends along a portion of the full length of the anode material 510.

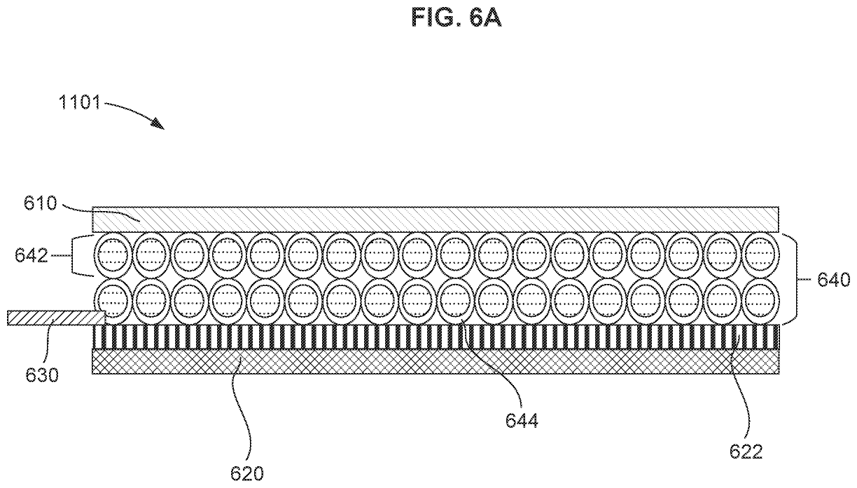

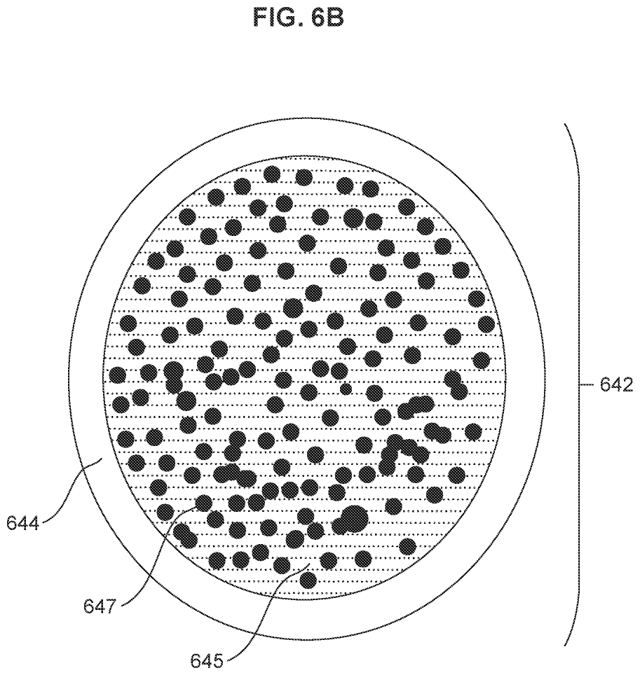

FIGS. 6A-6B illustrate an electrode 601, with a PTC material, according to an embodiment. As shown in FIG. 6A, the electrode 601 includes an electrode material 610 and an electrode film 620. The electrode 601 optionally includes an adhesive layer 622 and an electrode tab 630. The electrode 601 includes a PTC material 640. As shown, the PTC material 640 includes microcapsules 642 with conductive coatings 644. In some embodiments, the electrode material 610, the electrode film 620, the electrode tab 630, and the PTC material 640 can be the same or substantially similar to the electrode material 110, the electrode film 120, the electrode tab 130, and the PTC material 140, as described above with reference to FIG. 1. Thus, certain aspects of the electrode material 610, the electrode film 620, the electrode tab 630, and the PTC material 640 are not described in greater detail herein.

In some embodiments, the adhesive layer 622 can facilitate the attachment of the PTC material 640 to the electrode film 620. In some embodiments, the adhesive layer 622 can include an epoxy adhesive, a polyurethane adhesive, a polyimide adhesive, a paste adhesive, a liquid adhesive, a film adhesive, a pellet adhesive, a hot melt adhesive, or any combination thereof.

As shown, the microcapsules 642 are encapsulated by the conductive coatings 644. In some embodiments, upon reaching the threshold temperature, the microcapsules 642 can burst and/or melt, interrupting electrical contact between the electrode material 610 and a voltage source. In some embodiments, a threshold pressure can cause the microcapsules 642 to burst and/or melt, interrupting electrical contact between the electrode material 610 and the voltage source. In some embodiments, both a threshold temperature and a threshold pressure can contribute to the bursting and/or melting of the microcapsules 642.

In some embodiments, the threshold pressure can be at least about 1 bar, at least about 2 bar, at least about 3 bar, at least about 4 bar, at least about 5 bar, at least about 6 bar, at least about 7 bar, at least about 8 bar, at least about 9 bar, at least about 10 bar, at least about 20 bar, at least about 30 bar, at least about 40 bar, at least about 50 bar, at least about 60 bar, at least about 70 bar, at least about 80 bar, at least about 90 bar, at least about 100 bar, at least about 200 bar, at least about 300 bar, at least about 400 bar, at least about 500 bar, at least about 600 bar, at least about 700 bar, at least about 800 bar, or at least about 900 bar. In some embodiments, the threshold pressure can be no more than about 1,000 bar, no more than about 900 bar, no more than about 800 bar, no more than about 700 bar, no more than about 600 bar, no more than about 500 bar, no more than about 400 bar, no more than about 300 bar, no more than about 200 bar, no more than about 100 bar, no more than about 90 bar, no more than about 80 bar, no more than about 70 bar, no more than about 60 bar, no more than about 50 bar, no more than about 40 bar, no more than about 30 bar, no more than about 20 bar, no more than about 10 bar, no more than about 9 bar, no more than about 8 bar, no more than about 7 bar, no more than about 6 bar, no more than about 5 bar, no more than about 4 bar, no more than about 3 bar, or no more than about 2 bar. Combinations of the above-referenced threshold pressures are also possible (e.g., at least about 1 bar and no more than about 1,000 bar or at least about 50 bar and no more than about 500 bar), inclusive of all values and ranges therebetween. In some embodiments, the threshold pressure can be about 1 bar, about 2 bar, about 3 bar, about 4 bar, about 5 bar, about 6 bar, about 7 bar, about 8 bar, about 9 bar, about 10 bar, about 20 bar, about 30 bar, about 40 bar, about 50 bar, about 60 bar, about 70 bar, about 80 bar, about 90 bar, about 100 bar, about 200 bar, about 300 bar, about 400 bar, about 500 bar, about 600 bar, about 700 bar, about 800 bar, about 900 bar, or about 1,000 bar.

In some embodiments, the microcapsules 642 can include a resin. In some embodiments, the microcapsules 642 can include a plastic, an oligomer, a monomer, polyvinylidene fluoride (PVDF), polytetrafluoroethylene (PTFE), polyvinylchloride (PVC), polyester, polyethylene oxide (PEO), polypropylene (PP), or any combination thereof. In some embodiments, the microcapsules 642 can include one or more oils. In some embodiments, the microcapsules 642 can include a non-flammable oil. In some embodiments, the microcapsules 642 can include silicone oil, fluorine oil, or any combination thereof. In some embodiments, the microcapsules 642 can include a non-flammable liquid. In some embodiments, the microcapsules 642 can include water. In some embodiments, the microcapsules can include fluorine, chlorine, phosphate, bromine, a modified solvent, or any combination thereof. In some embodiments, the microcapsules 642 can include water with a solute. In some embodiments, the microcapsules 642 can include water with fluorine, chlorine, phosphate, bromine, a modified solvent, or any combination thereof. In some embodiments, the microcapsules 642 can include one or more gases. In some embodiments, the microcapsules 642 can include a non-flammable gas. In some embodiments, the microcapsules 642 can include any of the materials of the PTC material 140, as described above with reference to FIG. 1. In some embodiments, the microcapsules 642 can include argon, bromine, helium, fluorocarbon, nitrogen, carbon dioxide, or any combination thereof. In some embodiments, the material(s) in the microcapsules 642 can be mixed with electronically conductive powders. In some embodiments, if the electrode 601 is an anode, the electronically conductive powders can include copper, nickel, titanium, stainless steel, graphite, carbon, or any combination thereof. In some embodiments, if the electrode 601 is a cathode, the electronically conductive powders can include aluminum, platinum, gold, carbon, graphite, or any combination thereof.

In some embodiments, the microcapsules 642 can have diameters of at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, the microcapsules 642 can have diameters of no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, or no more than about 2 μm.

Combinations of the above-referenced diameters of the microcapsules 642 are also possible (e.g., at least about 1 μm and no more than about 1 mm or at least about 200 μm and no more than about 500 μm), inclusive of all values and ranges therebetween. In some embodiments, the microcapsules 642 can have diameters of about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1 mm. In some embodiments, measurement of the diameter of the microcapsules can include the thickness of the conductive coatings 644. In some embodiments, measurement of the diameter of the microcapsules can exclude the thickness of the conductive coatings 644.

In some embodiments, the microcapsules 642 can be heterogeneous, as shown in FIG. 6B. FIG. 6B shows a cross section of a single microcapsule 642. As shown, the microcapsule 642 includes the conductive coating 644 disposed thereon, a fill material 645, and matrix particles 647. In some embodiments, the conductive coating 644 can include a metal. In some embodiments, the conductive coating 644 can include a carbon. In some embodiments, the conductive coating 644 can include aluminum, copper, carbon, carbon black, activated carbon, carbon nanotubes, graphite, graphene, or any combination thereof. In some embodiments, the conductive coating 644 can include a resin. In some embodiments, the fill material 645 can include a gas, a liquid, a solution, a plastic, an oligomer, a monomer, polyvinylidene fluoride (PVDF), polytetrafluoroethylene (PTFE), polyvinylchloride (PVC), polyester, polyethylene oxide (PEO), polypropylene (PP), fluorine, chlorine, phosphate, bromine, a modified solvent, argon, bromine, helium, fluorocarbon, nitrogen, carbon dioxide, or any combination thereof. In some embodiments, the fill material 645 can include any of the materials of the PTC material 640, as described above with reference to FIG. 6. Upon reaching the threshold temperature and/or threshold pressure, the fill material 645 can exit the conductive coating 644. In some embodiments, the matrix particles 647 can include PTC materials. In some embodiments, the matrix particles 647 can include any of the materials of the PTC material 640, as described above with reference to FIG. 6. In some embodiments, the matrix particles 647 can expand with increasing temperature. In some embodiments, the matrix particles 647 can expand to be large enough to crack the conductive coating 644, releasing the fill material 645. In some embodiments, expansion of the matrix particles 647 can be cubically affected by temperature (i.e., the expansion of the matrix particles 647 can have a cubic relationship with temperature).

In some embodiments, the matrix particles 647 can include electronically conductive powders. In some embodiments, if the electrode 601 is an anode, the electronically conductive powders can include copper, nickel, titanium, stainless steel, graphite, carbon, or any combination thereof. In some embodiments, if the electrode 601 is a cathode, the electronically conductive powders can include aluminum, platinum, gold, carbon, graphite, or any combination thereof. In some embodiments, the matrix particles 647 can include electronically conductive materials disposed thereon. In some embodiments, if the electrode 601 is an anode, the electronically conductive materials can include copper, nickel, titanium, stainless steel, graphite, carbon, or any combination thereof. In some embodiments, if the electrode 601 is a cathode, the electronically conductive materials can include aluminum, platinum, gold, carbon, graphite, or any combination thereof.

In some embodiments, the fill material 645 can include a flame retardant material. When the matrix particles 647 expand and crack the conductive coating 644, the flame retardant material can be released from the microcapsules 642 to suppress ignition in the electrode 601. In some embodiments, the flame retardant material can include a spumific agent such as urea, urea-formaldehyde resins, dicyandiamide, melamine, polyamide, Li₂CO₃, NaHCO₃, PbCO₃, or any combination thereof. Examples include but are not limited to melamine cyanurate, melamine borate, melamine phosphate, melamine polyphosphate, melamine-poly(aluminum phosphate), or polycaprolactam. In some embodiments, the flame retardant material can include halogenated flame retardants such as organochlorines, organobromines, chlorinated paraffin, or any combination thereof. Examples include but are not limited to hexabromocyclododecane, decabromodiphenyl ether, tetrabromophthaiic anyhydrid, tetrabromobisphenol A (TBBPA), hexachlorocyclopentadiene, tetrachlorphthalic anhydride, chlorendic acid, polybrominated biphenyl (BB), polybrominated diphenyl ether (PBDE), hexabromocyclododecane (HBCD), 2,4,6-tribromophenol (TBP), or any combination thereof. In some embodiments, halogenated flame retardants may be used in conjunction with a synergist such as antimony trioxide, molybdenum trioxide, sodium antimonate, barium metaborate, ammonium fluoroborate. In some embodiments, the flame retardant material can include organophosphorous compounds such as triphenyl phosphate, esorcinol bis(diphenylphosphate), dimethyl methylphosphonate, or aluminium diethyl phosphinate. In some embodiments, the flame retardant material can include metal hydroxides such as aluminium trihydroxide, magnesium hydroxide, calcium hydroxide, potassium hydroxide, lithium hydroxide, or any combination thereof. In some embodiments, the flame retardant material can be a gel such as water containing a thickening agent such as sodium carboxymethylcellulose, sodium alginate, or calcium alginate with calcium chloride. In some embodiments, the flame retardant material can produce a flame-smothering foam above a threshold temperature.

The conductive coatings 644 can provide electronically conductive surface for operation of the electrode 601 when the temperature of the electrode 601 is below the threshold temperature. In some embodiments, if the electrode 601 is an anode, the conductive coatings 644 can include copper, nickel, aluminum, a copper-nickel alloy, a copper-nickel-aluminum alloy, titanium, stainless steel, carbon, or any combination thereof. In some embodiments, if the electrode 601 is a cathode, the conductive coatings 644 can include aluminum, platinum, gold, carbon, graphite, carbon, or any combination thereof. In some embodiments, the conductive coatings 644 can include a conductive paste. In some embodiments, the conductive coatings 644 can include any of the materials of the PTC material 640, as described above with reference to FIG. 6. In some embodiments, the conductive coatings 644 can have a thickness of at least about 50 nm, at least about 100 nm, at least about 150 nm, at least about 200 nm, at least about 250 nm, at least about 300 nm, at least about 350 nm, at least about 400 nm, at least about 450 nm, at least about 500 nm, at least about 550 nm, at least about 600 nm, at least about 650 nm, at least about 700 nm, at least about 750 nm, at least about 800 nm, at least about 850 nm, at least about 900 nm, at least about 950 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, or at least about 90 μm. In some embodiments, the conductive coatings 644 can have a thickness of no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, or no more than about 100 nm.

Combinations of the above-referenced thicknesses of the conductive coatings 644 are also possible (e.g., at least about 50 nm and no more than about 100 μm or at least about 200 nm and no more than about 1 μm), inclusive of all values and ranges therebetween. In some embodiments, the conductive coatings 644 can have a thickness of about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, or about 100 μm.

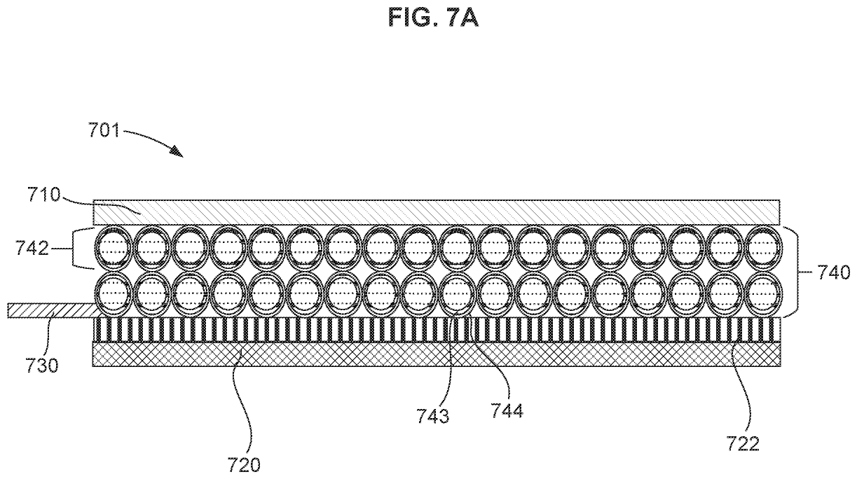

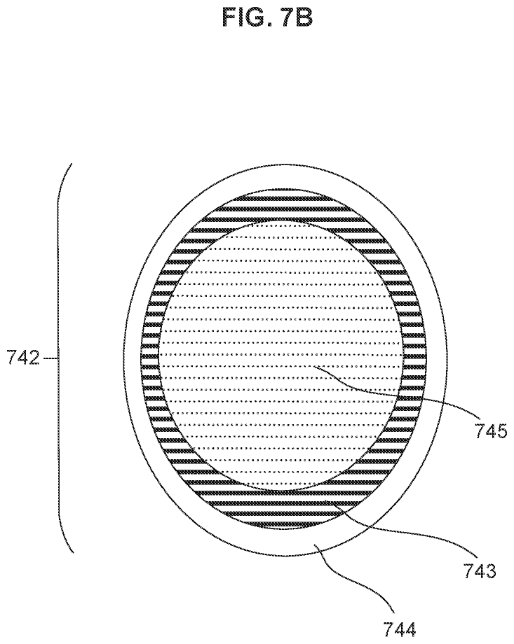

FIGS. 7A-7B are illustrations of an electrode 701, with a PTC material, according to an embodiment. As shown, the electrode 701 includes an electrode material 710 and an electrode film 720. The electrode 701 optionally includes an adhesive layer 722 and an electrode tab 730. The electrode 701 includes a PTC material 740. As shown, the PTC material 740 includes microcapsules 742 with PTC layers 743, conductive coatings 744, and fill material 745. In some embodiments, the electrode material 710, the electrode film 720, the adhesive layer 722, the electrode tab 730, the microcapsules 742, the conductive coatings 744, and the fill material 745 can be the same or substantially similar to the electrode material 610, the electrode film 620, the adhesive layer 622, the electrode tab 630, the microcapsules 642, the conductive coatings 644, and the fill material 645 as described above with reference to FIGS. 6A-6B. Thus, certain aspects of the electrode material 710, the electrode film 720, the adhesive layer 722, the electrode tab 730, the microcapsules 742, the conductive coatings 744, and the fill material 745 are not described in greater detail herein.

FIG. 7B shows a cross section of a single microcapsule 742, including the PTC layer 743, the conductive coating 744, and the fill material 745. The PTC layers 743 contain the fill material 745. Upon, expansion, the PTC layers 743 can rupture, allowing the fill material 745 to escape. Upon escaping, the fill material 745 can suppress ignition in the electrode 701. In some embodiments, the matrix particles 747 can include any of the materials of the PTC material 640, as described above with reference to FIG. 6. In some embodiments, the PTC layers 743 can have a thickness of at least about 50 nm, at least about 100 nm, at least about 150 nm, at least about 200 nm, at least about 250 nm, at least about 300 nm, at least about 350 nm, at least about 400 nm, at least about 450 nm, at least about 500 nm, at least about 550 nm, at least about 600 nm, at least about 650 nm, at least about 700 nm, at least about 750 nm, at least about 800 nm, at least about 850 nm, at least about 900 nm, at least about 950 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, or at least about 90 μm. In some embodiments, the PTC layers 743 can have a thickness of no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, or no more than about 100 nm.

Combinations of the above-referenced thicknesses of the PTC layers 743 are also possible (e.g., at least about 50 nm and no more than about 100 μm or at least about 200 nm and no more than about 1 μm), inclusive of all values and ranges therebetween. In some embodiments, the PTC layers 743 can have a thickness of about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, or about 100 μm.

The conductive coatings 744 provide additional conductive material on the outside of the microcapsules 742. In some embodiments, the conductive coatings 744 can reduce overpotential losses in the PTC material 740. The conductive coatings 744 can include thin film deposited material. In some embodiments, the conductive coatings 744 can be sputtered onto the PTC layers 743. In some embodiments, the conductive coatings 744 can be electrodeposited onto the PTC layers 743. In some embodiments, the conductive coatings 744 can be electroplated onto the PTC layers 743. In some embodiments, the conductive coatings 744 can include sputtered copper. In some embodiments, the conductive coatings 744 can include a conductive paste.

In some embodiments, the conductive coatings 744 can have a thickness of at least about 50 nm, at least about 100 nm, at least about 150 nm, at least about 200 nm, at least about 250 nm, at least about 300 nm, at least about 350 nm, at least about 400 nm, at least about 450 nm, at least about 500 nm, at least about 550 nm, at least about 600 nm, at least about 650 nm, at least about 700 nm, at least about 750 nm, at least about 800 nm, at least about 850 nm, at least about 900 nm, at least about 950 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, or at least about 90 μm. In some embodiments, the conductive coatings 744 can have a thickness of no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, or no more than about 100 nm.

Combinations of the above-referenced thicknesses of the conductive coatings 744 are also possible (e.g., at least about 50 nm and no more than about 100 μm or at least about 200 nm and no more than about 1 μm), inclusive of all values and ranges therebetween. In some embodiments, the conductive coatings 744 can have a thickness of about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, or about 100 μm.

### EXAMPLES

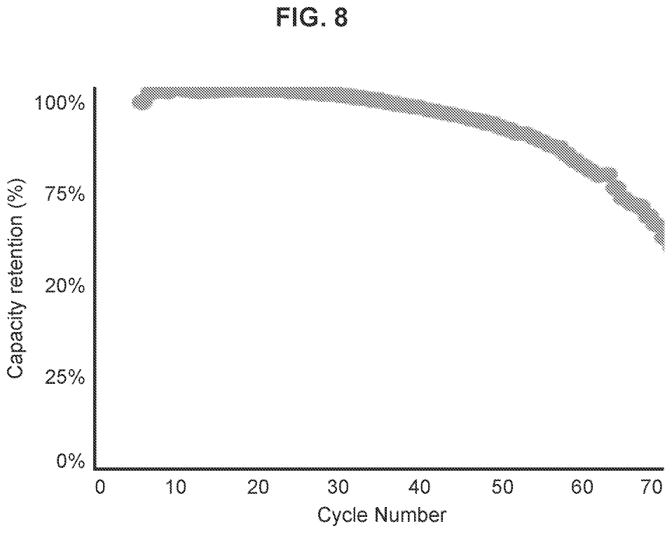

An electrochemical cell was constructed with a 2 μm thickness lithium anode and a LiNiMnCo (NMC) 811 cathode with a 200 μm thickness and an energy density of 11 mAh/cm². The electrochemical cell did not include an anode current collector, but only a weld tab coupled directly to the anode. The electrochemical cell was cycled between 4.3 V and 2.8 V at a 1 C discharge rate and 2 mA/cm² charge rate for 70 cycles at 25° C. FIG. 8 shows cycling data and capacity retention of the electrochemical cell over 70 cycles, with 100% capacity corresponding to a capacity of 170 mAh.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrode, comprising:
a layer of film material;
an electrode material disposed on the layer of film material; and
a positive temperature coefficient (PTC) material disposed on the electrode material, the PTC material configured to resist a flow of current through at least a portion of the PTC material when a temperature of the at least a portion of the PTC material exceeds a threshold temperature.

2. The electrode of claim 1, further comprising an electrode tab coupled to the PTC material and the electrode film.

3. The electrode of claim 1, wherein the PTC material includes a conductive polymer.

4. The electrode of claim 1, wherein the PTC material includes at least one of a bimetal inorganic material, a ceramic material, or a polymer with conductive filler particles dispersed therein.

5. The electrode of claim 1, wherein the electrode material includes a semi-solid and/or binderless electrode material.

6. The electrode of claim 1, wherein the PTC material extends along a full length of the electrode material.

7. The electrode of claim 1, wherein the PTC material includes microcapsules encapsulated by conductive coatings.

8. The electrode of claim 7, wherein the microcapsules include at least one of a resin, a gas, or a liquid.

9. The electrode of claim 7, wherein the microcapsules include at least one of a plastic, an oligomer, a monomer, polyvinylidene fluoride (PVDF), polytetrafluoroethylene (PTFE), polyvinylchloride (PVC), polyester, polyethylene oxide (PEO), or a polypropylene (PP).

10. The electrode of claim 7, wherein the microcapsules include silicone oil and/or fluorine oil.

11. The electrode of claim 7, wherein the conductive coatings include at least one of copper, nickel, titanium, stainless steel, or carbon.

12. The electrode of claim 7, wherein the conductive coatings include at least one of aluminum, platinum, gold, carbon, graphite, or carbon.

13. The electrode of claim 7, wherein the microcapsules include a shell with a fill material and matrix particles disposed therein.

14. The electrode of claim 15, wherein the fill material includes a flame retardant material.

15. The electrode of claim 7, wherein the microcapsules include PTC particles disposed therein, the PTC particles configured to expand upon a temperature increase and rupture the microcapsules.

16. An electrode, comprising:
an electrode material;
a PTC material directly coupled to the electrode material, the PTC material configured to resist a flow of current through at least a portion of the PTC material when a temperature of the at least a portion of the PTC material exceeds a threshold temperature; and
an electrode tab directly coupled to the PTC material, the electrode tab configured to be connected to a voltage source.

17. The electrode of claim 16, wherein the PTC material includes a conductive polymer.

18. The electrode of claim 16, wherein the PTC material includes at least one of a bimetal inorganic material, a ceramic material, or a polymer with conductive filler particles dispersed therein.

19. The electrode of claim 16, wherein the PTC material extends along a full length of the electrode material.

20. The electrode of claim 16, wherein the PTC material includes microcapsules encapsulated by conductive coatings.

21. The electrode of claim 20, wherein the microcapsules include at least one of a resin, a gas, or a liquid.

22. The electrode of claim 20, wherein the microcapsules include at least one of a plastic, an oligomer, a monomer, polyvinylidene fluoride (PVDF), polytetrafluoroethylene (PTFE), polyvinylchloride (PVC), polyester, polyethylene oxide (PEO), or a polypropylene (PP).

23. The electrode of claim 20, wherein the microcapsules include silicone oil and/or fluorine oil.

24. An electrochemical cell, comprising:
a first electrode material disposed on a first electrode film;
a second electrode material disposed on a second electrode film;
a separator disposed between the first electrode material and the second electrode material;
a first electrode tab electrically coupled to the first electrode;
a PTC material directly coupled to the second electrode material, the PTC material configured to resist a flow of current through at least a portion of the PTC material when a temperature of the at least a portion of the PTC material exceeds a threshold temperature; and
a second electrode tab directly coupled to the PTC material.

25. The electrochemical cell of claim 24, wherein the PTC material includes microcapsules encapsulated by conductive coatings.

26. The electrochemical cell of claim 25, wherein the microcapsules include at least one of a resin, a gas, or a liquid.

27. The electrochemical cell of claim 25, wherein the microcapsules include at least one of a plastic, an oligomer, a monomer, polyvinylidene fluoride (PVDF), polytetrafluoroethylene (PTFE), polyvinylchloride (PVC), polyester, polyethylene oxide (PEO), or a polypropylene (PP).

28. The electrochemical cell of claim 25, wherein the microcapsules include silicone oil and/or fluorine oil.

29. The electrochemical cell of claim 24, wherein the threshold temperature is between about 80° C. and about 150° C.

30. The electrochemical cell of claim 24, wherein at least one of the first electrode or the second electrode includes a semi-solid electrode.
